(19) United States
(12) Patent Application Publication
(10) Pub. No.: US 2025/0140462 A1
(43) Pub. Date: May 1, 2025

(54) ELECTROMAGNET FOR AUTOMATIC TRANSFER SWITCH AND CORRESPONDING AUTOMATIC TRANSFER SWITCH

(71) Applicant: ABB SCHWEIZ AG, Baden (CH)

(72) Inventor: Tianyi Huang, Xiamen (CN)

(21) Appl. No.: 18/885,935

(22) Filed: Sep. 16, 2024

(30) Foreign Application Priority Data
Oct. 30, 2023 (CN) 202311423111.9

(51) Int. Cl. H01F 7/16

(52) U.S. Cl. CPC H01F 7/1646; H01F 2007/1692

(57) ABSTRACT

An electromagnet for an automatic transfer switch and a corresponding automatic transfer switch. The electromagnet includes a static iron core, a coil, a magnetic yoke and a movable iron core. The static iron core is fixedly disposed on a base and at an end of the electromagnet. The coil has an annular shape and is disposed adjacent to the static iron core. The magnetic yoke is disposed between the coil and the static iron core and defines an inner space together with the static iron core and the coil. The movable iron core is partially disposed within the inner space and configured to move between a first position and a second position relative to the static iron core along a center axis of the electromagnet.

### FIELD

The present disclosure generally relates to the electrical field, and specifically to an electromagnet for an automatic transfer switch and a corresponding automatic transfer switch.

### BACKGROUND

An automatic transfer switch is a device capable of providing emergency power supply, which is typically called “dual-power automatic transfer switch” or “dual-power switch” in the electrical industry. The automatic transfer switch is often used for switching between two power sources. If one power source fails or stops supplying power, the automatic transfer switch can quickly perform the switch to the other power source, thus ensuring normal power supply of the load circuit.

At present, the automatic transfer switch is typically driven by an electromagnet. In general, the automatic transfer switch needs to complete switch from one power source to the other power source within 100 ms, which causes the electromagnet to withstand large instantaneous power. In the existing structure, the force of the electromagnet increases nonlinearly with the reduction of an air gap, which leads to a low energy conversion efficiency in practice and a severe mechanical shock when the contacts are closed, thus greatly affecting the mechanical life performance of the product.

### SUMMARY

In order to at least partly solve the problem and/or other potential problems, embodiments of the present disclosure provide an electromagnet for an automatic transfer switch and a corresponding automatic transfer switch.

In a first aspect of the present disclosure, there is provided an electromagnet for an automatic transfer switch. The electromagnet comprises: a static iron core fixedly disposed on a base and at an end of the electromagnet; a coil having an annular shape and disposed adjacent to the static iron core; a magnetic yoke disposed between the coil and the static magnetic core and defining an inner space together with the static iron core and the coil; and a movable iron core partially disposed within the inner space and configured to move between a first position and a second position relative to the static iron core along a central axis of the electromagnet, wherein at least a part of the coil and at least a part of the magnetic yoke are disposed on a movement stroke between the first position and the second position of the movable iron core.

According to the embodiments of the present disclosure, the impact force generated by the electromagnet during the state transfer of the automatic transfer switch can be effectively reduced, thus improving the performance of the electromagnet.

In some embodiments, the static iron core comprises a protrusion having a size in a cross section perpendicular to the central axis that decreases inwardly along the central axis; and the movable iron core on a side facing the static iron core comprises a recess matching the protrusion.

In some embodiments, the protrusion and the recess have a conical or stepped shape.

In some embodiments, the electromagnet further comprises an actuating rod coupled to the movable iron core, wherein the movable iron core comprises a recess for insertion of the actuating rod, and an end of the recess comprises an escape hole.

In some embodiments, the electromagnet further comprises: a further static iron core fixedly disposed on the base and at a further end of the electromagnet; a further coil having an annular shape and disposed adjacent to the further static iron core; and a further magnetic yoke disposed between the further coil and the further static magnetic core and defining the inner space together with the static iron core, the coil, the further static iron core and the further coil.

In some embodiments, at least a part of the further coil and at least a part of the further magnetic yoke are disposed in the movement stroke between the first position and the second position of the movable iron core.

In some embodiments, the magnetic yoke and the further magnetic yoke have different sizes in a direction parallel to the central axis.

In some embodiments, the further static iron core comprises a further protrusion having a size in a cross section perpendicular to the central axis that decreases inwardly along the central axis; and the movable iron core on a side facing the further static iron core comprises a further recess matching the further protrusion.

In a second aspect of the present disclosure, there is provided an automatic transfer switch. The automatic transfer switch comprises the electromagnet in the first aspect of the present disclosure.

### BRIEF DESCRIPTION OF THE DRAWINGS

In order to make embodiments of the present disclosure clear, brief introduction on the drawings required by the embodiments will be provided below. It would be appreciated that the accompanying drawings only show some embodiments of the present disclosure and thus should not be construed as limitations to the scope. On the basis of those drawings, those skilled in the art could derive other related drawings, without doing creative work.

FIG. 1 is a perspective view of an automatic transfer switch according to example embodiments of the present disclosure.

FIG. 2 is a front view of the automatic transfer switch in FIG. 1.

FIG. 3 is a schematic overview of an electromagnet according to example embodiments of the present disclosure.

FIG. 4 is a schematic cross-sectional view of an electromagnet according to embodiments of the present disclosure when in a first position.

FIG. 5 is a schematic cross-sectional view of an electromagnet according to embodiments of the present disclosure when in a second position.

### DETAILED DESCRIPTION OF IMPLEMENTATIONS

Reference will now be made to the drawings to describe in detail implementations of the present disclosure. Although the drawings illustrate some implementations of the present disclosure, it would be appreciated that the present disclosure can be implemented in various forms and should not be construed as being limited to the implementations described herein. Rather, those implementations are provided to enable a more thorough and complete understanding on those implementations. It is to be understood that the drawings and implementations of the present disclosure are only provided exemplarily, rather than limit the protection scope of the present disclosure.

As used herein, the terms “includes” and its variants are to be read as open terms that mean “includes, but is not limited to.” The term “based on” is to be read as “based at least in part on.” The terms “an embodiment/implementation” or “the embodiment/implementation” is to be read as “at least one embodiment/implementation.” The terms “first,” “second,” and the like may indicate the same or different objects. Other definitions, either explicit or implicit, may be included thereinafter.

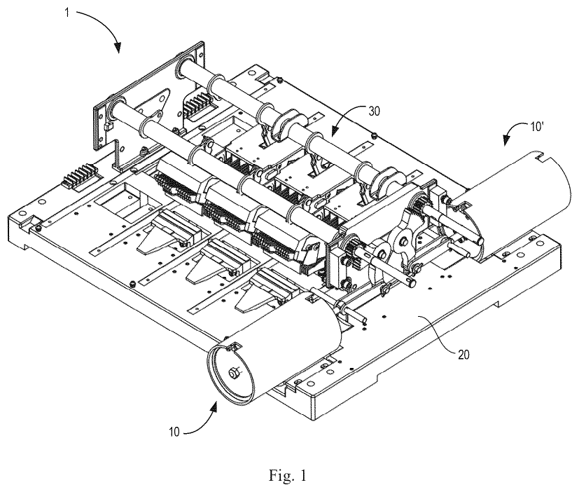

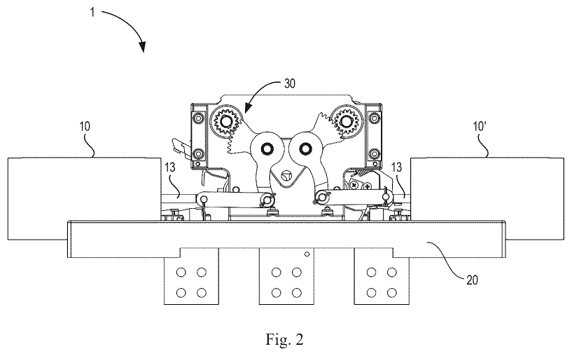

FIG. 1 is a perspective view of an automatic transfer switch 1 according to example embodiments of the present disclosure. FIG. 2 is a front view of the automatic transfer switch in FIG. 1. The automatic transfer switch 1 includes two power sources, for example, a normal power source and a backup power source. The normal power source operates in a normal condition to supply power to a load. The automatic transfer switch 1 further includes an electromagnet 10, 10′ and a transmission mechanism 30 connected to the electromagnet 10, 10′. If the normal power source fails, the transmission mechanism 30 will be driven to move as an effect of the electromagnet 10, 10′, to quickly achieve a disconnection from the normal power source and a connection with the backup power source. In this case, the backup power source provides power to the load, to thus guarantee normal operation of the load.

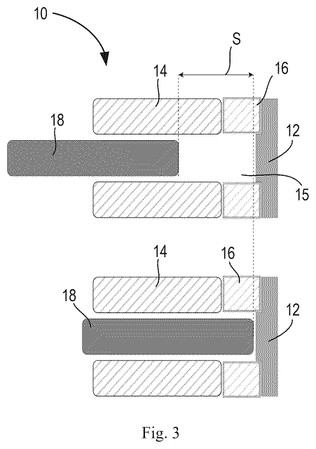

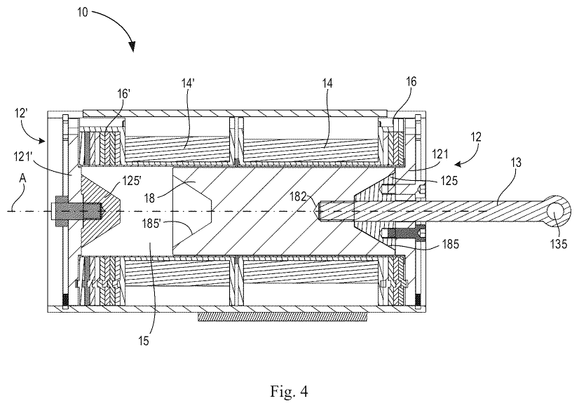

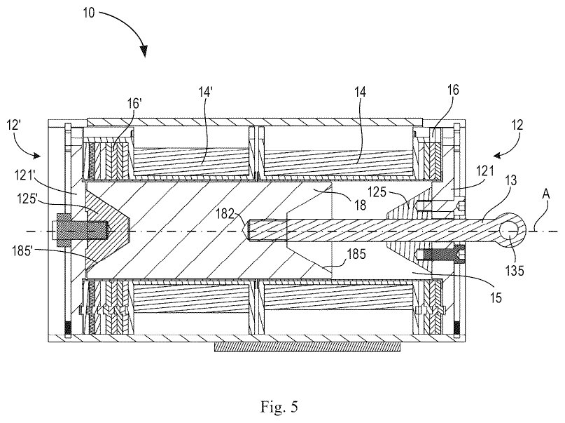

FIG. 3 is a schematic overview of an electromagnet 10 according to embodiments of the present disclosure, and FIGS. 4 and 5 are schematic cross-sectional views of the electromagnet according to embodiments of the present disclosure when in different movement stages.

As shown in FIGS. 3-5, the electromagnet 10 is generally of a cylindrical shape and includes a static iron core 12, a coil 14, a magnetic yoke 16 and a movable iron core 18. The static iron core 12 includes an end cover 121 fixedly disposed on a base and at an end of the electromagnet 10. Returning to FIG. 1, the base may be a fixed portion 20 of the automatic transfer switch 1. In other words, the static iron core 12 may be regarded as a stationary part. As shown in FIGS. 3-5, the coil 14 is disposed adjacent to the static iron core 12 and arranged annularly outside the electromagnet 10. The magnetic yoke 16 is arranged side by side relative to the coil 14 and is arranged between the coil 14 and the static iron core 12, and defines an inner space 15 together with the static iron core 12 and the coil 14.

The movable iron core 18 can partially move within the inner space 15. Referring to the upper part of FIG. 3 and FIG. 4, the movable iron core 18 can move along a central axis A of the electromagnet 10 to a limit position farthest from the static iron core 12. Referring to the lower part of FIG. 3 and FIG. 5, the movable iron core 18 can move along the central axis A of the electromagnet 10 to a limit position closest to the static iron core 12. As shown in FIG. 3, a movement stroke 2 of the movable iron core 18 can be obtained between the two limit positions, and at least a part of the coil 14 and at least a part of the magnetic yoke 16 are disposed in the movement stroke S of the movable iron core 18.

According to the embodiments of the present disclosure, the electromagnetic force of the electromagnet changes in a parabolic shape as the air gap decreases during the closing process. This structure can fully optimize the structural design of the electromagnet to improve its dynamic characteristics.

In some embodiments, as shown in FIGS. 4 and 5, the static iron core 12 includes a protrusion 125, where a size of the protrusion 125 in a cross section perpendicular to the central axis A decreases inwardly along the central axis A. In the illustrated embodiments, the protrusion 125 of the static iron core 12 is conical, i.e., the conical surface of the static iron core 12 bulges outwards. Correspondingly, the movable static core 18 on a side facing the static iron core 12 includes a recess 185 matching the protrusion 125. In the illustrated embodiments, the recess 185 of the movable iron core 18 is conical, i.e., the conical surface of the movable iron core 18 is recessed inwardly and matches the conical surface of the static iron core 12. Such a structure can guide the deflection of the magnetic flux lines. This cannot only reduce the magnetic resistance between the air gaps, but can also enable the movable iron core 18 to quickly reach magnetic saturation, thereby greatly improving its dynamic performance.

It is to be understood that, although the protrusion 125 of the static iron core 12 and the recess 185 of the movable iron core 18 are both shown in a conical shape, this is provided only as an example, without limitation. In other possible embodiments, the protrusion 125 of the static iron core 12 may also be in a stepped shape, and the recess 185 of the movable iron core 18 may correspondingly have a stepped shape. Of course, other shapes may be employed as long as the protrusion 125 of the movable iron core 12 matches the recess 185 of the movable iron core 18. These shapes all fall into the protection scope of the present disclosure.

As shown in FIGS. 4 and 5, one end of the actuating rod 13 is inserted into the recess of the movable iron core 18, and an end of the recess is provided with an escape hole 182. The escape hole 182 is used to guarantee that metal debris can be discharged smoothly when threads for connecting the actuating rod 13 are being machined. It is to be understood that the escape hole 182 may be in the form of a cone as shown in FIGS. 4 and 5, or may be in the form of a frustum, which is not limited in the embodiments of the present disclosure. Such shape can facilitate processing and manufacturing of the movable iron core 18 and the static iron core 125, to thus reduce the manufacturing cost.

In some embodiments, referring to FIG. 4 or 5, the magnetic yoke 16 may be in the form of a stack of sheets, which can reduce the cost. In addition, since there is an air gap having a relatively larger magnetic resistance between stacked sheets of the magnetic yoke 16, this gap guides the deflection of the magnetic flux lines and increases attenuation of the magnetic force, to thus prevent the electromagnet 10 from generating a great impact during transfer and further optimize the performance of the electromagnet 10.

In some embodiments, referring to FIGS. 4 and 5, the static iron core and the corresponding coil and magnetic yoke are provided on both ends of the electromagnet 10. In other words, in addition to the static iron core 12 and the corresponding coil 14 and magnetic yoke 16 on the right side of FIGS. 4 and 5, the electromagnet 10 may include a further set of a static iron core, a coil and a magnetic yoke. Specifically, in the illustrated embodiments, the electromagnet 10 includes a further static iron core 12′ on the left side thereof, where the static iron core 12′ is fixedly disposed on the base and at the other end of the electromagnet 10. The electromagnet 10 may also include a further coil 14′ having an annular shape and disposed adjacent to the further static iron core 12′. The electromagnet 10 may include a further magnetic yoke 16′. As shown, the further magnetic yoke 16′ is disposed between the further coil 14′ and the further static iron core 12′, and defines the inner space 15 together with the static iron core 12, the coil 14, the further static iron core 12′ and the further coil 14′. In some embodiments, at least a part of the further coil 14′ and at least a part of the further magnetic yoke 16′ are arranged in the movement stroke S between the first position and the second position of the movable iron core 18.

In some embodiments, as shown in FIGS. 4 and 5, the further static iron core 12′ may include a further protrusion 125′ similar to the protrusion 125 described above, where a size of the further protrusion 125′ in a cross section perpendicular to the central axis A decreases inwardly along the central axis A. Correspondingly, the movable iron core 18 on a side facing the further static iron core 12′ includes a further recess 185′ matching the further protrusion 125′. Such a structure allows the electromagnetic force to significantly decrease when the tip of the movable iron core 18 exceeds the coil, to thus reducing the impact force of closing and opening significantly.

In some embodiments, as shown in FIGS. 4 and 5, the magnetic yoke 16 and the further magnetic yoke 16′ have different sizes in the direction parallel to the central axis A. Since the opening and closing forces of the switch are often inconsistent, the asymmetric design of the magnetic yokes takes the inconsistency into consideration, to further improve the performance of the electromagnet 10.

Hereinafter, description will be made on the working process of the electromagnet 10 according to the example embodiments as shown in FIGS. 4 and 5. Referring to FIGS. 4 and 5, the electromagnet 10 is coupled to the actuating rod 13. When one power source (e.g. the normal power source) on a side fails, the control component (not shown) may send a control signal to the electromagnet 10, to supply power to the corresponding coil 14′. Meanwhile, the movable iron core 18 is located on the position in FIG. 4. After the coil 14′ is energized, the movable iron core 18 moves towards the static core 12′ on the left side of FIG. 4 as an effect of the electromagnetic force, to thus drive the actuating rod 13 to move to the position in FIG. 5. The actuating rod 13 may be connected via a connection hole 135 to a series of transmission mechanisms 30 as shown in FIGS. 1 and 2, to thus disconnect from the failed power source.

Almost simultaneously with the disconnection from the failed power source, or after a certain time since the disconnection from the failed power source, the control component sends a control signal to the electromagnet 10, to supply power to the coil 14 on the other side (i.e., the non-fault side). Meanwhile, the iron core 18 is located on the position in FIG. 5. After the coil 14 is energized, the movable iron core 18 moves towards the static iron core 12 on the right side of FIG. 5 as an effect of the electromagnet force, to thus drive the actuating rod 13 to move to the position in FIG. 4. The actuating rod 13 may be connected via the connection core 135 to the series of transmission mechanism 30 shown in FIGS. 1 and 2, to thus implement a connection with the backup power source and finally achieve quick switch from the failed power source to the backup power source.

The embodiments of the present disclosure also relate to an automatic transfer switch 1 including the electromagnet 10 described above. It is to be understood that the electromagnet 10 according to the embodiments of the present disclosure may be applied to different types of automatic transfer switches. That is, the electromagnet 10 according to the embodiments of the present disclosure may be double-coil bidirectional electromagnet shown in FIGS. 4 and 5, or may be a single-coil unidirectional electromagnet. The electromagnets of these types shall all fall into the protection scope of the present disclosure.

The objectives, technical solutions, and advantageous effects of the present disclosure have been described in detail in the foregoing specific implementations. It should be understood that the foregoing descriptions are merely about implementations of the present disclosure, without suggesting any limitation to the protection scope of the present disclosure. Any modification, equivalent replacement, or improvement without departing from the spirits and principle of the present disclosure shall fall within the protection scope of the present disclosure.

1. An electromagnet for an automatic transfer switch, comprising:
a static iron core fixedly disposed on a base and at an end of the electromagnet;
a coil having an annular shape and disposed adjacent to the static iron core;
a magnetic yoke disposed between the coil and the static magnetic core and defining an inner space together with the static iron core and the coil; and
a movable iron core partially disposed within the inner space and configured to move between a first position and a second position relative to the static iron core along a central axis of the electromagnet,
wherein at least a part of the coil and at least a part of the magnetic yoke are disposed on a movement stroke between the first position and the second position of the movable iron core.

2. The electromagnet of claim 1,
wherein the static iron core comprises a protrusion having a size in a cross section perpendicular to the central axis that decreases inwardly along the central axis; and
wherein the movable iron core on a side facing the static iron core comprises a recess matching the protrusion.

3. The electromagnet of claim 2, wherein the protrusion and the recess have a conical or stepped shape.

4. The electromagnet of claim 1 , further comprising:
an actuating rod coupled to the movable iron core,
wherein the movable iron core comprises a recess for insertion of the actuating rod, and
an end of the recess comprises an escape hole.

5. The electromagnet of claim 1, further comprising:
a further static iron core fixedly disposed on the base and at a further end of the electromagnet;
a further coil having an annular shape and disposed adjacent to the further static iron core; and
a further magnetic yoke disposed between the further coil and the further static magnetic core and defining the inner space together with the static iron core, the coil, the further static iron core and the further coil.

6. The electromagnet of claim 5,
wherein at least a part of the further coil and at least a part of the further magnetic yoke are disposed in the movement stroke between the first position and the second position of the movable iron core.

7. The electromagnet of claim 5, wherein the magnetic yoke and the further magnetic yoke have different sizes in a direction parallel to the central axis.

8. The electromagnet of claim 5,
wherein the further static iron core comprises a further protrusion having a size in a cross section perpendicular to the central axis that decreases inwardly along the central axis; and
wherein the movable iron core on a side facing the further static iron core comprises a further recess matching the further protrusion.

9. An automatic transfer switch, comprising the electromagnet of claim 1.

10. The electromagnet of claim 2, further comprising:
an actuating rod coupled to the movable iron core,
wherein the movable iron core comprises a recess for insertion of the actuating rod, and
an end of the recess comprises an escape hole.

11. The electromagnet of claim 3, further comprising:
an actuating rod coupled to the movable iron core,
wherein the movable iron core comprises a recess for insertion of the actuating rod, and
an end of the recess comprises an escape hole.

12. The electromagnet of claim 2, further comprising:
a further static iron core fixedly disposed on the base and at a further end of the electromagnet;
a further coil having an annular shape and disposed adjacent to the further static iron core; and
a further magnetic yoke disposed between the further coil and the further static magnetic core and defining the inner space together with the static iron core, the coil, the further static iron core and the further coil.

13. The electromagnet of claim 12,
wherein at least a part of the further coil and at least a part of the further magnetic yoke are disposed in the movement stroke between the first position and the second position of the movable iron core.

14. The electromagnet of claim 12, wherein the magnetic yoke and the further magnetic yoke have different sizes in a direction parallel to the central axis.

15. The electromagnet of claim 12,
wherein the further static iron core comprises a further protrusion having a size in a cross section perpendicular to the central axis that decreases inwardly along the central axis; and
wherein the movable iron core on a side facing the further static iron core comprises a further recess matching the further protrusion.

16. The electromagnet claim 3, further comprising:
a further static iron core fixedly disposed on the base and at a further end of the electromagnet;
a further coil having an annular shape and disposed adjacent to the further static iron core; and
a further magnetic yoke disposed between the further coil and the further static magnetic core and defining the inner space together with the static iron core, the coil, the further static iron core and the further coil.

17. The electromagnet of claim 16,
wherein at least a part of the further coil and at least a part of the further magnetic yoke are disposed in the movement stroke between the first position and the second position of the movable iron core.

18. The electromagnet of claim 16, wherein the magnetic yoke and the further magnetic yoke have different sizes in a direction parallel to the central axis.

19. The electromagnet of claim 16,
wherein the further static iron core comprises a further protrusion having a size in a cross section perpendicular to the central axis that decreases inwardly along the central axis; and
wherein the movable iron core on a side facing the further static iron core comprises a further recess matching the further protrusion.
